(19) United States
(12) Patent Application Publication
(10) Pub. No.: US 2023/0199005 A1
(43) Pub. Date: Jun. 22, 2023

(54) METHOD AND APPARATUS FOR DETECTING NETWORK ATTACK BASED ON FUSION FEATURE VECTOR

(71) Applicant: ELECTRONICS AND TELECOMMUNICATIONS RESEARCH INSTITUTE, Daejeon (KR)

(72) Inventors: Hyeok-Chan KWON, Daejeon (KR); Byung-Ho CHUNG, Daejeon (KR)

(73) Assignee: ELECTRONICS AND TELECOMMUNICATIONS RESEARCH INSTITUTE, Daejeon (KR)

(21) Appl. No.: 17/978,164

(22) Filed: Oct. 31, 2022

(30) Foreign Application Priority Data
Dec. 17, 2021 (KR) 10-2021-0181375

(51) Int. Cl. H04L 9/40

(52) U.S. Cl. CPC H04L 63/1416; H04L 63/1425

(57) ABSTRACT

Disclosed herein is a method for detecting a network attack based on a fusion feature vector. The method includes extracting feature vectors corresponding to a preset unit time from network traffic, generating fusion feature vectors based on the extracted feature vectors, and performing training using the generated fusion feature vectors.

### CROSS REFERENCE TO RELATED APPLICATION

This application claims the benefit of Korean Patent Application No. 10-2021-0181375, filed Dec. 17, 2021, which is hereby incorporated by reference in its entirety into this application.

### BACKGROUND OF THE INVENTION

### 1. Technical Field

The present invention relates to technology for detecting a network attack based on network traffic characteristics.

More particularly, the present invention relates to technology for generating various feature sets based on network traffic and using the same for detecting a network attack.

### 2. Description of the Related Art

As technologies for responding to various cyberattacks such as ransomware, DDoS attacks, and the like, there are technologies for detecting abnormal traffic by learning and analyzing network traffic through machine learning, deep learning, and the like. Learning and analyzing network traffic are mainly performed in units of flows. Here, a network flow may include information such as a source IP address, a source port, a destination IP address, a destination port, a protocol, and the like.

The existing technologies include a method of collecting and learning features of a single flow (e.g., a start time, a source IP address, a destination IP address, a direction, the total number of packets, the total number of bytes, and the like) and a method of generating and learning statistical features of a set of flows (e.g., the number of flows, the average duration of flows, the entropy of destination IP addresses, and the like). However, because network traffic has various characteristics, the existing methods are not adequate to sufficiently analyze characteristics of network traffic. Also, as a network environment becomes more complicated and as cyberattacks become more sophisticated, the existing methods have limitations in sufficiently using abundant information of network traffic.

Accordingly, the present invention proposes technology for generating three kinds of feature sets for each time window based on network traffic, generating a new fusion feature vector by combining/fusing the feature sets, and learning, analyzing, and using the fusion feature vector to detect a network attack.

### DOCUMENTS OF RELATED ART

(Patent Document 1) Korean Patent Application Publication No. 10-2020-0069632, titled “Method, apparatus, and computer program using software-defined network to avoid DDoS attack”.

### SUMMARY OF THE INVENTION

An object of the present invention is to detect a network attack based on network traffic characteristics.

Another object of the present invention is to extract information from network traffic in any of various manners and to effectively analyze the same.

In order to accomplish the above objects, a method for detecting a network attack based on a fusion feature vector according to an embodiment of the present invention includes extracting feature vectors corresponding to a preset unit time from network traffic, generating fusion feature vectors based on the extracted feature vectors, and performing training using the generated fusion feature vectors.

Here, the feature vectors may include a first feature vector extracted from each packet in the network traffic, a second feature vector extracted from respective flows in the network traffic, and a third feature vector extracted from a flow set within the preset unit time.

Here, the first feature vector may be generated based on a feature set representing features of a preset number of packets for each of the flows in the network traffic.

Here, the second feature vector may be generated based on a feature set representing features of the flows in the network traffic.

Here, the third feature vector may be generated based on a feature set representing features of the flow set within the preset unit time.

Here, generating the fusion feature vectors may comprise generating the fusion feature vectors using common variables present in the first feature vector, the second feature vector, and the third feature vector.

Here, features of the packet may include the size of the packet, the size of an IP packet header, an inter-arrival time, the direction of the packet, an inter-arrival time according to the direction of the packet, and the flag value of the packet.

Here, the features of the flows may include basic flow information, flow duration, a flow direction, a flow state, and the number of packets.

Here, the features of the flow set may include the number of flows, variety of destination IP addresses, and statistical information on flows in the flow set.

Here, the basic flow information may include a source IP address, a source port, a destination IP address, a destination port, and protocol information.

Also, in order to accomplish the above objects, an apparatus for detecting a network attack based on a fusion feature vector according to an embodiment of the present invention includes an extraction unit for extracting feature vectors corresponding to a preset unit time from network traffic, a fusion unit for generating fusion feature vectors based on the extracted feature vectors, and a learning unit for performing training using the generated fusion feature vectors.

Here, the feature vectors may include a first feature vector extracted from each packet in the network traffic, a second feature vector extracted from respective flows in the network traffic, and a third feature vector extracted from a flow set within the preset unit time.

Here, the first feature vector may be generated based on a feature set representing features of a preset number of packets for each of the flows in the network traffic.

Here, the second feature vector may be generated based on a feature set representing features of the flows in the network traffic.

Here, the third feature vector may be generated based on a feature set representing features of the flow set within the preset unit time.

Here, the fusion unit may generate the fusion feature vectors using common variables present in the first feature vector, the second feature vector, and the third feature vector.

Here, features of the packet may include the size of the packet, the size of an IP packet header, an inter-arrival time, the direction of the packet, an inter-arrival time according to the direction of the packet, and the flag value of the packet.

Here, the features of the flows may include basic flow information, flow duration, a flow direction, a flow state, and the number of packets.

Here, the features of the flow set may include the number of flows, variety of destination IP addresses, and statistical information on flows in the flow set.

Here, the basic flow information may include a source IP address, a source port, a destination IP address, a destination port, and protocol information.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a flowchart illustrating a method for detecting a network attack based on a fusion feature vector according to an embodiment of the present invention;

FIG. 2 is a view conceptually illustrating a method for detecting a network attack according to an embodiment of the present invention;

FIG. 3 is a view conceptually illustrating the structure of a packet feature vector and a method of configuring the same;

FIG. 4 is a view conceptually illustrating the structure of a flow feature vector and a method of configuring the same;

FIG. 5 is a view conceptually illustrating the structure of an environment feature vector and a method of configuring the same;

FIG. 6 is a block diagram illustrating an apparatus for detecting a network attack based on a fusion feature vector according to an embodiment of the present invention; and

FIG. 7 is a view illustrating the configuration of a computer system according to an embodiment.

### DESCRIPTION OF THE PREFERRED EMBODIMENTS

The advantages and features of the present invention and methods of achieving the same will be apparent from the exemplary embodiments to be described below in more detail with reference to the accompanying drawings. However, it should be noted that the present invention is not limited to the following exemplary embodiments, and may be implemented in various forms. Accordingly, the exemplary embodiments are provided only to disclose the present invention and to let those skilled in the art know the category of the present invention, and the present invention is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present invention.

The terms used herein are for the purpose of describing particular embodiments only, and are not intended to limit the present invention. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitively defined in the present specification.

Hereinafter, embodiments of the present invention will be described in detail with reference to the accompanying drawings. In the following description of the present invention, the same reference numerals are used to designate the same or similar elements throughout the drawings, and repeated descriptions of the same components will be omitted.

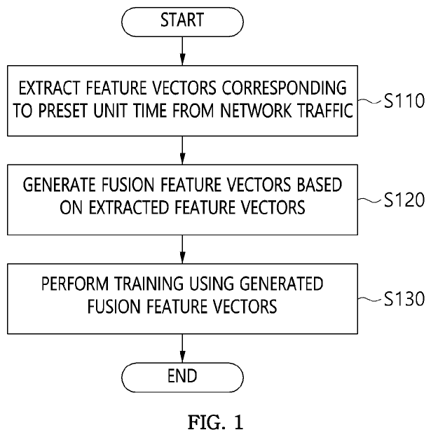

FIG. 1 is a flowchart illustrating a method for detecting a network attack based on a fusion feature vector according to an embodiment of the present invention.

The method for detecting a network attack based on a fusion feature vector according to an embodiment of the present invention may be performed by an apparatus for detecting a network attack.

Referring to FIG. 1, in the method for detecting a network attack based on a fusion feature vector according to an embodiment of the present invention, feature vectors corresponding to a preset unit time are extracted from network traffic at step S110.

Subsequently, fusion feature vectors are generated based on the extracted feature vectors at step S120, and training is performed using the generated fusion feature vectors at step S130. Here, the generated fusion feature vectors may be fusion feature vectors respectively corresponding to multiple time sections.

Here, the feature vectors may include a first feature vector extracted from each packet in the network traffic, a second feature vector extracted from respective flows in the network traffic, and a third feature vector extracted from a flow set within the preset unit time.

Here, the first feature vector, the second feature vector, and the third feature vector may correspond to a packet feature vector, a flow feature vector, and an environment feature vector, respectively.

Here, the first feature vector may be generated based on a feature set representing the features of a preset number of packets for each of the flows in the network traffic.

Here, the second feature vector may be generated based on a feature set representing the features of the flows in the network traffic.

Here, the third feature vector may be generated based on a feature set representing the features of the flow set within the preset unit time.

Here, generating a fusion feature vector at step S120 may comprise generating a fusion feature vector using common variables present in the first feature vector, the second feature vector, and the third feature vector. Here, the common variables may include an index corresponding to the preset unit time, a flow index, a packet index, and the like, but the scope of the present invention is not limited thereto.

Here, the features of a packet may include the size of the packet, the size of an IP packet header, an inter-arrival time, the direction of the packet, an inter-arrival time according to the direction of the packet, and the flag value of the packet.

Here, the features of flows may include basic flow information, flow duration, a flow direction, a flow state, and the number of packets.

Here, the features of a flow set may include the number of flows, variety of destination IP addresses, and statistical information on flows in the flow set.

Here, the basic flow information may include a source IP address, a source port, a destination IP address, a destination port, and protocol information.

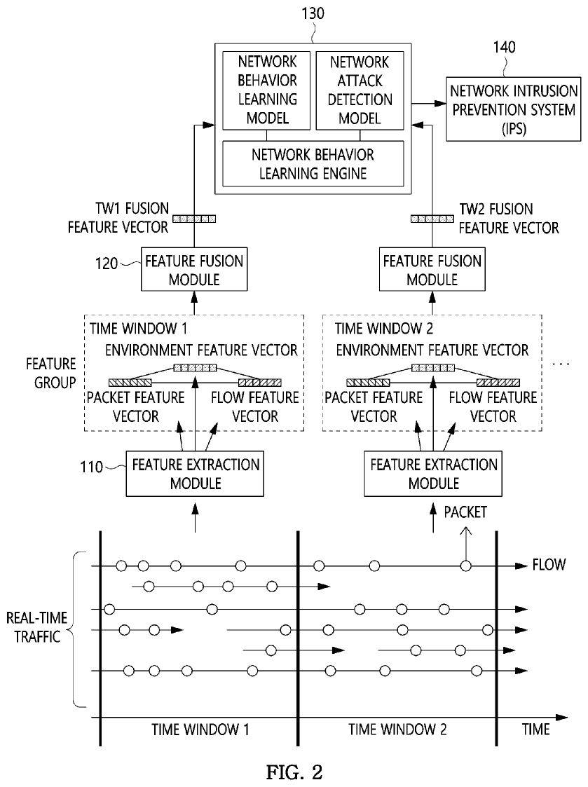

FIG. 2 is a view conceptually illustrating a method for detecting a network attack according to an embodiment of the present invention.

The respective arrows in the real-time traffic shown in FIG. 2 indicate network flows. Here, the start point of an arrow indicates the time at which a flow starts and the end point thereof indicates the time at which the flow ends. Here, the flow may be configured with a source IP address, a source port, a destination IP address, a destination port, and a protocol.

In FIG. 2, the parts represented as small circles on the flow indicate packets. Here, the packets may be individual packets of Internet Control Message Protocol (ICMP), User Datagram Protocol (UDP), Transmission Control Protocol (TCP), Address Resolution Protocol (ARP), and the like. A time window, which is a unit of time for configuring a feature set, may have a variable length depending on network security policies and settings. Here, the length of each time window may be set to a minute, ten minutes, an hour, or the like, but the scope of the present invention is not limited thereto.

A feature extraction module 110 is a module for analyzing network traffic and generating multiple feature sets. Referring to FIG. 2, it can be seen that three kinds of feature sets, including a packet feature vector, a flow feature vector, and an environment feature vector, are generated for each time window. The structure and operation method of the feature extraction module 110 are not included in the scope of the present invention, and existing tools, such as Wireshark, Open Argus, and the like, may be used.

Here, the packet feature vector may be a feature vector extracted from each packet. Here, the flow feature vector may be a feature vector extracted from a single flow. Here, the environment feature vector may be a environment feature vector extracted from a flow set in the time window. Also, these three kinds of feature vectors may constitute a feature group.

A feature fusion module 120 is a module for generating a new fusion feature vector by fusing and profiling the above-mentioned three kinds of feature sets. As in the case of the feature extraction module 110, the structure and operation method of the feature fusion module 120 are not included in the scope of the present invention, and a fusion feature vector may be generated through association analysis to which linear algebra, and the like are applied. Here, the fusion feature vector may be a feature vector generated by combining and fusing the three kinds of feature vectors for a specific time window.

A network learning module 130 may include a network behavior learning engine, a network behavior learning model, and a network attack detection model. The network behavior learning engine is a module for learning the finally generated fusion feature vector, and existing machine-learning/deep-learning technology may be applied thereto. Here, a time-series packet analysis method using a Recurrent Neural Network (RNN), Long Short Term Memory (LSTM), a Gated Recurrent Unit (GRU) model, or the like, a learning method merged with a Convolution Neural Network (CNN), a multi-layer perceptron (MLP), a statistical model, or a machine-learning model, and a method of partitioning or rearranging a recurrent neural network using an auto-encoder may be used as detailed learning methods.

The network behavior learning model and the network attack detection model are generated through the network behavior learning engine, and these models are used by a network Intrusion Prevention System (IPS) 140 in order to detect an attack.

Referring to FIG. 2, the feature extraction module 110 analyzes real-time network traffic, thereby generating three kinds of feature vectors for each time window.

The generated three kinds of feature vectors are fused/combined and profiled by the feature fusion module 120, whereby a new fusion feature vector is generated.

The generated fusion feature vector for each time window is learned by a machine-learning/deep-learning engine. The network attack detection method is similar to existing methods, and the following methods may be used.

a model is generated by learning normal traffic, after which real-time traffic is learned and whether abnormal behavior occurs is detected (1-class classification).

labeled traffic (traffic labeled as being normal or abnormal for each flow) is analyzed, whereby a fusion feature vector is generated (the fusion feature vector also being labeled as being normal or abnormal). After a model is generated by learning the fusion feature vector, real-time traffic is learned based on the detection model, whereby whether traffic is normal or abnormal is detected (2-class classification).

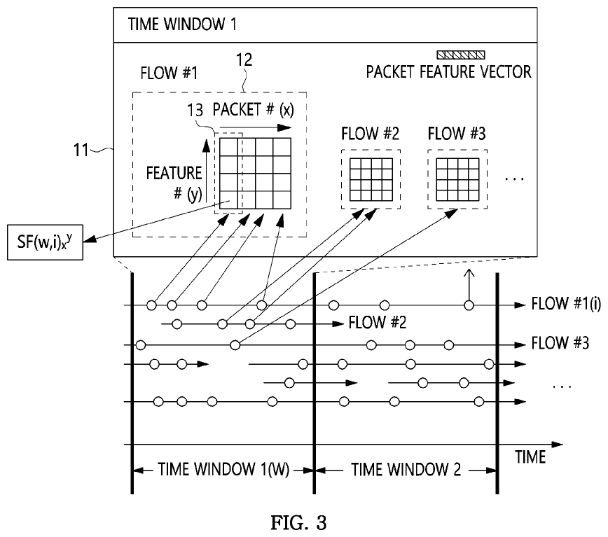

FIG. 3 is a view conceptually illustrating the structure of a packet feature vector and a method of configuring the same.

A packet feature vector may correspond to a set of feature vectors extracted from respective packets. FIG. 3 shows the structure of the packet feature vector generated in time window 1. Referring to FIG. 3, a feature set 12 for flow i, a feature set 13 for packet x, and a feature vector 11 for time window w are illustrated. A two-dimensional feature set (X*Y) 12 is generated for each flow in a time window, and a number of feature sets equal to the number of flows (I) in the time window may be present. The number of packets (X) may be the number of packets included in a specific flow in the time window. However, in this case, a large amount of information may be generated, and feature sets (X*Y) of respective flows may have different sizes. Accordingly, in consideration of performance, the ease of feature fusion and learning, and the like, features only for first n packets of a flow are extracted and used to generate a feature set. Accordingly, the value of X may be set to be equal to n, which is the number of packets extracted from a flow that is defined in the policy.

Data included in each element of the two-dimensional feature set may be represented as SF(w, i)ₓ^{y}, and the notation has the following meaning:

SF(w, i)ₓ^{y}: the y-th feature value of packet x of flow i in window w

SF: a sequence feature

w: a time window number (time window #)

i: a flow number (flow #)

x: a packet number (packet #)

y: a feature number (feature #)

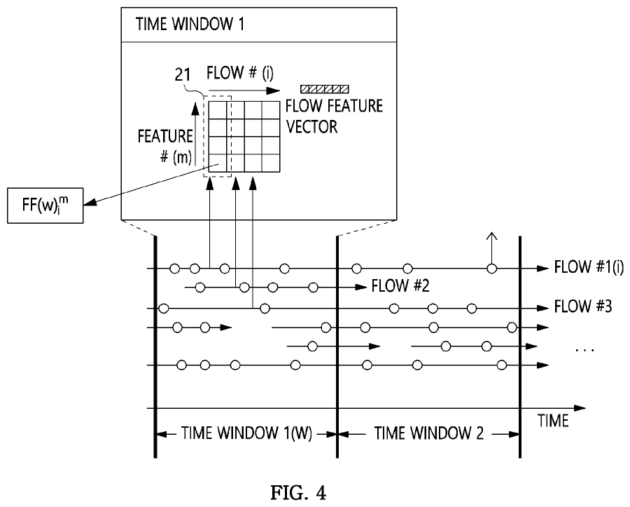

FIG. 4 is a view conceptually illustrating the structure of a flow feature vector and a method of configuring the same.

A flow feature vector may correspond to a set of feature vectors extracted from a single flow. Referring to FIG. 4, the features 21 of respective flows in a time window are extracted, whereby a two-dimensional feature set (M*I) is generated. The value of M is the number of features extracted from each flow, and the value of I is the number of flows in the time window. Data included in each element of the two-dimensional feature set may be represented as FF(w)ᵢ^{m}, and the notation has the following meaning:

FF(w)ᵢ^{m}: the m-the feature value of flow i of window w

FF: a flow feature

w: a time window number (time window #)

i: a flow number (flow #)

m: a feature number (feature #)

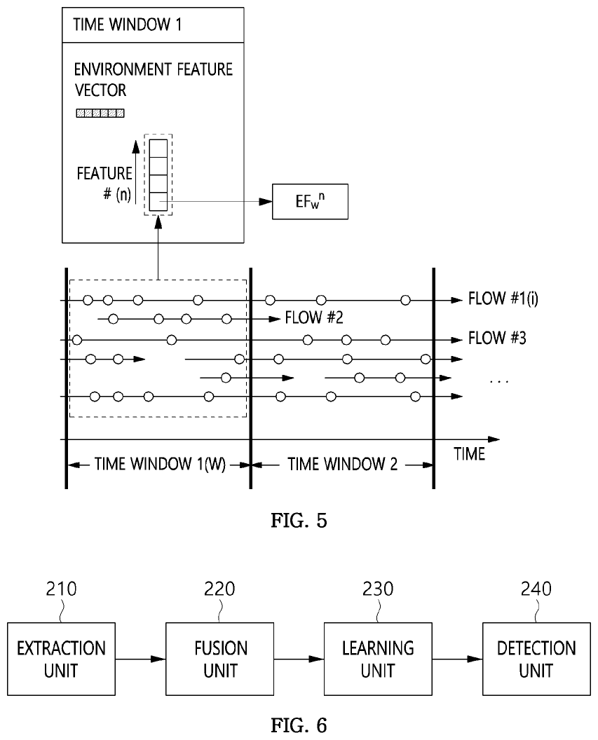

FIG. 5 is a view conceptually illustrating the structure of an environment feature vector and a method of configuring the same.

An environment feature vector may correspond to a set of environment feature vectors extracted from a flow set in a time window. Referring to FIG. 5, respective flows in a time window are collected, whereby a one-dimensional feature set (1*N) is generated. Here, the value of N is the number of environmental characteristics (features) extracted from the flow set of a time window. Data included in each element of the one-dimensional feature set may be represented as EF_{w}ⁿ, and the notation has the following meaning:

EF_{w}ⁿ: the n-the feature value of window w

EF: an environment feature

w: a time window number (time window #)

n: a feature number (feature #)

Here, variables common among a packet feature vector, a flow feature vector, and an environment feature vector are present. For example, variables w and i are common both to the packet feature vector SF(w, i)ₓ^{y}and to the flow feature vector FF(w)ᵢ^{m}. Also, variable w is common both to the flow feature vector FF(w)ᵢ^{m} and to the environment feature vector EF_{w}ⁿ. Accordingly, the feature vectors may be fused using the common variables.

Here, a packet feature vector extracted from a packet may include features such as the size of the packet (bytes), the size of an IP packet header, an inter-arrival time, the direction of the packet, an inter-arrival time according to the direction, flag values of the packet (DF flag, MF flag, and the like), and the like.

Here, a flow feature vector extracted from a single flow may include features such as basic flow information (a source IP address, a source port, a destination IP address, a destination port, and a protocol), flow duration, a direction, a state, the total number of packets, the total number of packets according to a direction, a total size (bytes), a total size according to a direction (bytes), an inter-arrival time according to a direction, the number of packets per second, and the like.

Here, an environment feature vector extracted for each time window may include features such as the total number of flows, variety of destination IP addresses, states (INT, RST, FIN, CON), the proportion of active flows among IP address pairs, and the like.

Also, the environment feature vector may further include characteristics on statistical information such as statistics on protocols (TCP, UDP, ARP, ICMP, and the like) (e.g., the mean, the maximum value, the minimum value, the standard deviation, and the like of the number of flows for each protocol, the number of packets, packet sizes, and the like) and statistical information on some features of a flow feature vector (e.g., the mean, the maximum value, the minimum value, the standard deviation, and the like of the mean duration of flows, variety of destination IP addresses, states, the number of packets per second, and the like).

FIG. 6 is a block diagram illustrating an apparatus for detecting a network attack based on a fusion feature vector according to an embodiment of the present invention.

Referring to FIG. 6, the apparatus for detecting a network attack based on a fusion feature vector according to an embodiment includes an extraction unit 210 for extracting feature vectors corresponding to a preset unit time from network traffic, a fusion unit 220 for generating fusion feature vectors based on the extracted feature vectors, and a learning unit 230 for performing training using the generated fusion feature vectors. Also, the apparatus may further include a detection unit 240 for detecting a network attack.

Here, the feature vectors may include a first feature vector extracted from each packet in the network traffic, a second feature vector extracted from respective flows in the network traffic, and a third feature vector extracted from a flow set within the preset unit time.

Here, the first feature vector may be generated based on a feature set representing the features of a preset number of packets for each of the flows in the network traffic.

Here, the second feature vector may be generated based on a feature set representing the features of the flows in the network traffic.

Here, the third feature vector may be generated based on a feature set representing the features of the flow set within the preset unit time.

Here, the fusion unit 220 may generate a fusion feature vector using common variables present in the first feature vector, the second feature vector, and the third feature vector.

Here, the features of the packet may include the size of the packet, the size of an IP packet header, an inter-arrival time, the direction of the packet, an inter-arrival time according to the direction of the packet, and the flag value of the packet.

Here, the features of the flows may include basic flow information, flow duration, a flow direction, a flow state, and the number of packets.

Here, the features of the flow set may include the number of flows, variety of destination IP addresses, and statistical information on the flows in the flow set.

Here, the basic flow information may include a source IP address, a source port, a destination IP address, a destination port, and protocol information.

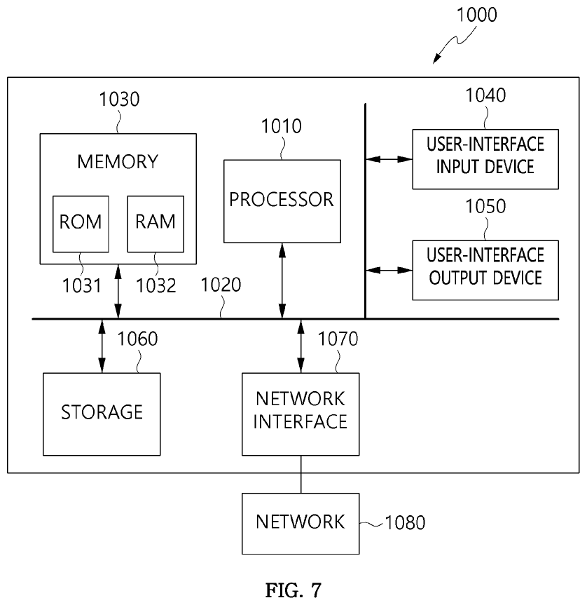

FIG. 7 is a view illustrating the configuration of a computer system according to an embodiment.

The apparatus for detecting a network attack based on a fusion feature vector according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected to a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

The present invention may be used for detecting abnormal behavior and anomalies in a network in order to detect attacks such as ransomware, DDoS attacks, and the like at a network level. Specifically, the fusion feature vector of the present invention is learned and analyzed, whereby network attacks may be detected using the following methods.

a model is generated by learning normal traffic, after which real-time traffic is learned and whether abnormal behavior occurs is detected (1-class classification).

labeled traffic (traffic labeled as being normal or abnormal for each flow) is analyzed, whereby a fusion feature vector is generated (the fusion feature vector also being labeled as being normal or abnormal). After a model is generated by learning the fusion feature vector, real-time traffic is learned based on the detection model, whereby whether traffic is normal or abnormal is detected (2-class classification).

Also, when it is difficult to detect an attack in an application by using a security module mounted on a device, such as a hospital medical device or the PLC of a control system, monitoring and detection have to be performed at a network level independently of the terminal. Here, multidimensional analysis and learning of network behavior are performed by applying this technology, whereby abnormal behavior and threats may be detected.

According to the present invention, a network attack may be detected based on network traffic characteristics.

Also, the present invention may extract information from network traffic in any of various manners and effectively analyze the same.

Specific implementations described in the present invention are embodiments and are not intended to limit the scope of the present invention. For conciseness of the specification, descriptions of conventional electronic components, control systems, software, and other functional aspects thereof may be omitted. Also, lines connecting components or connecting members illustrated in the drawings show functional connections and/or physical or circuit connections, and may be represented as various functional connections, physical connections, or circuit connections that are capable of replacing or being added to an actual device. Also, unless specific terms, such as “essential”, “important”, or the like, are used, the corresponding components may not be absolutely necessary.

Accordingly, the spirit of the present invention should not be construed as being limited to the above-described embodiments, and the entire scope of the appended claims and their equivalents should be understood as defining the scope and spirit of the present invention.

What is claimed is:

1. A method for detecting a network attack based on a fusion feature vector, comprising:
extracting feature vectors corresponding to a preset unit time from network traffic;
generating fusion feature vectors based on the extracted feature vectors; and
performing training using the generated fusion feature vectors.

2. The method of claim 1, wherein the feature vectors include a first feature vector extracted from each packet in the network traffic, a second feature vector extracted from respective flows in the network traffic, and a third feature vector extracted from a flow set within the preset unit time.

3. The method of claim 2, wherein the first feature vector is generated based on a feature set representing features of a preset number of packets for each of the flows.

4. The method of claim 3, wherein the second feature vector is generated based on a feature set representing features of the flows in the network traffic.

5. The method of claim 4, wherein the third feature vector is generated based on a feature set representing features of the flow set within the preset unit time.

6. The method of claim 5, wherein generating the fusion feature vectors comprises generating the fusion feature vectors using common variables present in the first feature vector, the second feature vector, and the third feature vector.

7. The method of claim 3, wherein features of the packet include a size of the packet, a size of an IP packet header, an inter-arrival time, a direction of the packet, an inter-arrival time according to the direction of the packet, and a flag value of the packet.

8. The method of claim 4, wherein the features of the flows include basic flow information, flow duration, a flow direction, a flow state, and a number of packets.

9. The method of claim 5, wherein the features of the flow set include a number of flows, variety of destination IP addresses, and statistical information on flows in the flow set.

10. The method of claim 8, wherein the basic flow information includes a source IP address, a source port, a destination IP address, a destination port, and protocol information.

11. An apparatus for detecting a network attack based on a fusion feature vector, comprising:
an extraction unit for extracting feature vectors corresponding to a preset unit time from network traffic;
a fusion unit for generating fusion feature vectors based on the extracted feature vectors; and
a learning unit for performing training using the generated fusion feature vectors.

12. The apparatus of claim 11, wherein the feature vectors include a first feature vector extracted from each packet in the network traffic, a second feature vector extracted from respective flows in the network traffic, and a third feature vector extracted from a flow set within the preset unit time.

13. The apparatus of claim 12, wherein the first feature vector is generated based on a feature set representing features of a preset number of packets for each of the flows.

14. The apparatus of claim 13, wherein the second feature vector is generated based on a feature set representing features of the flows in the network traffic.

15. The apparatus of claim 14, wherein the third feature vector is generated based on a feature set representing features of the flow set within the preset unit time.

16. The apparatus of claim 15, wherein the fusion unit generates the fusion feature vectors using common variables present in the first feature vector, the second feature vector, and the third feature vector.

17. The apparatus of claim 13, wherein features of the packet include a size of the packet, a size of an IP packet header, an inter-arrival time, a direction of the packet, an inter-arrival time according to the direction of the packet, and a flag value of the packet.

18. The apparatus of claim 14, wherein the features of the flows include basic flow information, flow duration, a flow direction, a flow state, and a number of packets.

19. The apparatus of claim 15, wherein the features of the flow set include a number of flows, variety of destination IP addresses, and statistical information on flows in the flow set.

20. The apparatus of claim 18, wherein the basic flow information includes a source IP address, a source port, a destination IP address, a destination port, and protocol information.
